(19) United States
(12) Patent Application Publication
(10) Pub. No.: US 2005/0263986 A1
(43) Pub. Date: Dec. 1, 2005

(54) Tandem axle suspension assembly

(76) Inventors: Steven R. Miller, Clarkston, MI (US); Mark P. Reynolds, Birmingham, MI (US); James Eckelberry, Canton, OH (US); Robert P. Carlstedt, Rochester Hills, MI (US); Daniel G. Chien, Franklin, MI (US); Kenneth G. Lang, Davison, MI (US); Martin Peaker, Upton (GB); Nancy L. Saxon, Oakland Township, MI (US); Jos Timmermans, Ortonville, MI (US); Jeff Lloyd, Auburn Hills, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/853,956

(22) Filed: May 26, 2004

(51) Int. Cl. B60G 5/00

(52) U.S. Cl. 280/683

(57) ABSTRACT

A vehicle suspension assembly includes a control rod pivotally connected between a vehicle frame and an axle. The control rod controls longitudinal and vertical movement of the axle. A spring member is pivotally connected to the frame and fixed to the axle. Air spring assemblies are mounted between the axle and frame. The rigidly mounted spring member exerts torsion forces on the axle to counter roll forces and the air spring assemblies provide favorable ride characteristics adaptable to various trailer load conditions.

### BACKGROUND OF THE INVENTION

This invention generally relates to a tandem axle suspension assembly, and more specifically to a walking beam tandem axle suspension assembly.

Typically, vehicles such as cargo trailers include a steel leaf spring for suspending an axle from a vehicle frame. The steel leaf spring suspension requires little maintenance and provides favorable loading dock performance. The favorable dock performance results from a relatively small amount of vertical displacement between loaded and unloaded conditions of the leaf spring suspension. However, the leaf spring suspension may provide relatively harsh ride characteristics during unloaded or lightly loaded conditions.

Another trailer suspension utilizes air springs for each axle. The air springs provide favorable ride characteristics regardless of the load on the trailer. Further, specific ride characteristics can be tailored to a specific load and desired handling characteristics.

Disadvantageously, an air suspension system may be more expensive than a comparable leaf spring suspension. Air spring suspension systems may also not provide optimal loading dock performance due to height variations between loaded and unloaded conditions. In some instances, conventional air spring suspension systems utilize mechanical add on devices such as an adjustable stop inserted between the trailer frame and the suspension to limit movement relative to a loading dock. Other devices include manually operated jacks that support the trailer at a fixed height. Such devices typically require manual operation before, during and after the loading process. As appreciated, these mechanical add on devices increase weight, expense, and maintenance requirements.

Accordingly, it is desirable to develop an air spring suspension system with favorable loading dock performance without sacrificing favorable ride characteristics.

### SUMMARY OF INVENTION

The suspension assembly of the present invention includes a pivotally attached control rod and a spring member fixed to an axle and pivotally attached to a vehicle frame.

An air spring assembly is mounted between the axle and the vehicle frame to provide desirable ride characteristics. The control rod includes a first connection to the vehicle frame and a second connection to the axle. The control rod constrains longitudinal and vertical movement of the axle. The spring member is rigidly attached to the axle to counteract forces that can cause roll movements of the vehicle. The rigidly mounted spring member exerts torsion forces on the axle to counter roll forces while the air spring assemblies provide favorable ride characteristics adaptable to various trailer load conditions.

Accordingly, the suspension assembly of this invention provides favorable loading dock performance and favorable ride characteristics without additional add on devices.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a perspective view of a tandem axle suspension assembly according to this invention;

FIG. 2 is a schematic view of the axle assembly shown in FIG. 1;

FIG. 3 is a schematic view of the suspension assembly with the axles moved away from a neutral position;

FIG. 4, is a perspective view of another tandem axle suspension assembly according to this invention;

FIG. 5 is a schematic view of the axle assembly shown in FIG. 4; and

FIG. 6 is a schematic view of the axle assembly with the axles moved away from a neutral position.

### DETAILED DESCRIPTION OF THE PREFERRED EMBODIMENT

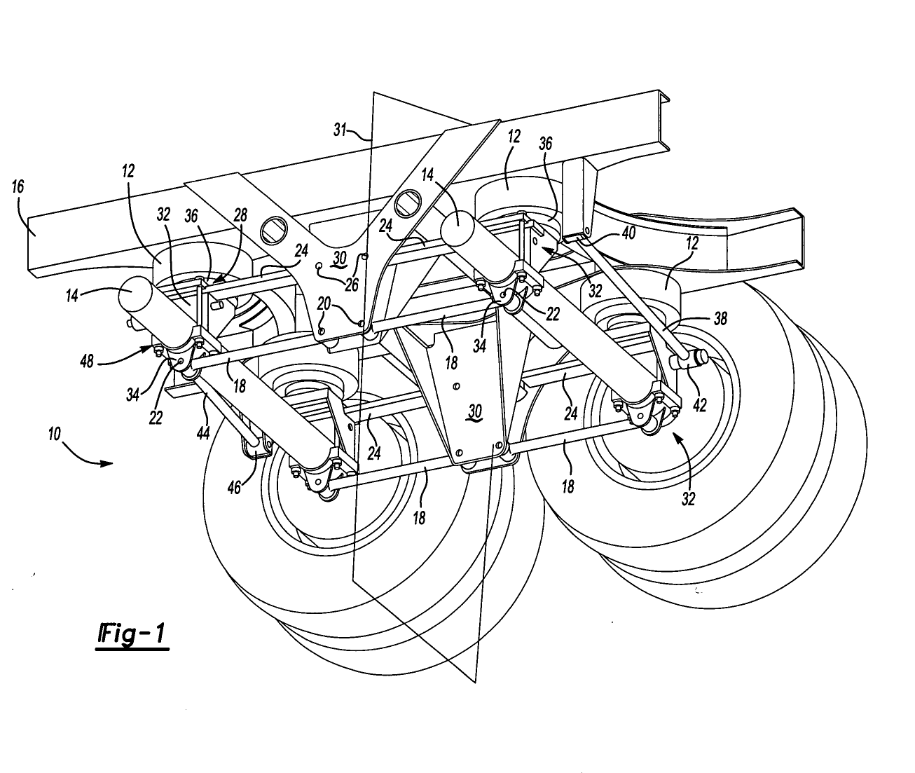

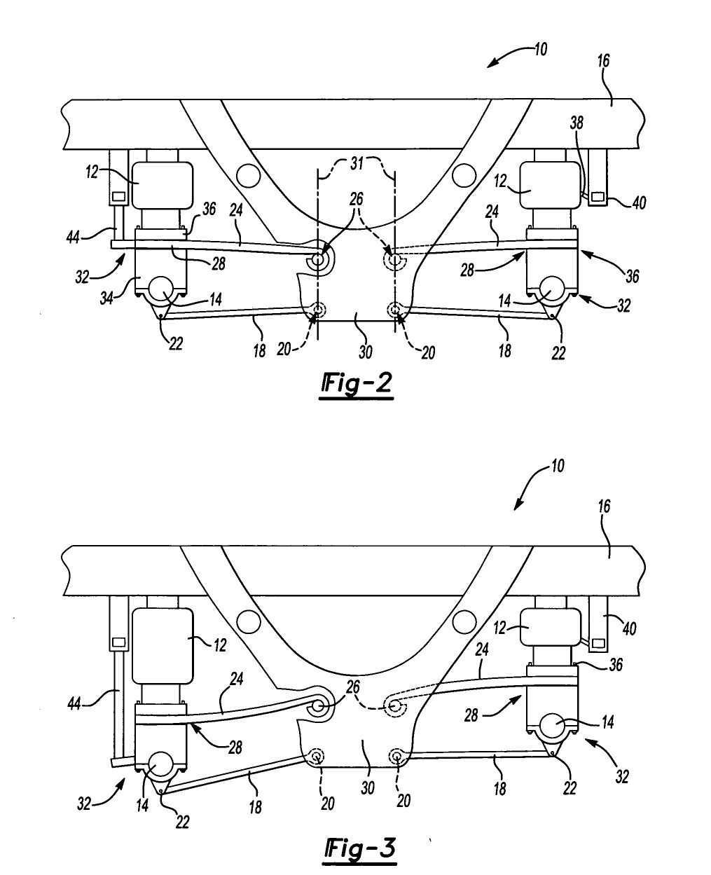

Referring to FIGS. 1 and 2, a tandem axle suspension assembly 10 includes a pair of axles 14, each supported by an air spring assembly 12 relative to a frame 16. Preferably, the suspension assembly 10 supports axles 14 that are not driven such as are commonly used for cargo trailers, however, a driven axle system may also benefit from the suspension assembly 10 of this invention.

A control rod 18 includes a pivotal connection 20 to a fixed link plate 30 that is rigidly attached to the frame 16. The control rod 18 includes a pivotal connection 22 to an axle mount 32 supporting one of the axles 14. The control rod 18 constrains longitudinal and vertical movement of the axles 14 relative to the frame 16.

A spring member 24 includes a pivotal connection 26 to the link plate 30 and fixed connection 28 to the axle mount 32 below the air spring assembly 12. Preferably, the spring member 24 is a leaf spring having a desired thickness, however, the spring member 24 can also comprise other spring structures, such as rods or plates that exert a biasing force. The axle mount 32 includes a mount plate 36 and an axle plate 34. The spring member 24 is clamped between the mount plate 36 and the axle plate 34 and secured together by a threaded fastener. The control rod 18 attaches below the axle 14 and the spring member 24 attaches above the axle 14, however, it is within the contemplation of this invention to reverse the position of the spring member 24 and control rod 18.

The spring member 24 and the control rod 18 are connected parallel to each other forming top and bottom movable linkages between the axles 14 and the link plate 30. Both the pivotal connection 20 for the control rod 18 and the pivotal connection 26 for the spring member 24 are disposed within a common vertical plane 31. The pivotal connections 20, 26 support vertical displacement of the axles 14 to accommodate road inconsistencies.

A first lateral control arm 38 and a second lateral control arm 44 are attached between the frame 16 and the axle mount 32 to control lateral movement of the axles 14. The first lateral control arm 38 includes a first segment 40 attached to the frame 16 and a second segment 42 attached to the axle mount 32. The second control arm 44 includes a first segment 46 attached to the frame 16 and a second segment 48 attached to another axle mount 32.

Preferably, the air spring assemblies 12 are of a minimal stroke to limit overall vertical movement of the axles 14 relative to the frame 16 once air is exhausted. The minimal movement between the frame 16 and the axles 14 improves dock performance by minimizing height changes during unloading.

Referring to FIG. 3, the spring member 24 is rigidly attached to the axle mount 32 at the fixed connection 28 to control roll of the axle 14 relative to the frame 16. The spring member 24 exerts a torsion force on the axle 14 to at least partially counteract forces that cause roll.

Vertical movement of the axles 14 is resisted by the spring member 24. The spring members 24 bend in response to vertical movement of the axles 14 from a neutral position (Illustrated by FIG. 2). FIG. 3 illustrates movement of one axle 14 away from the frame 16 and movement of another axle 14 toward the frame 16 along with the accompanying bend of the spring member 24. The magnitude of bend on the spring member 24 is greatly exaggerated to illustrate operation.

The air spring assemblies 12 provide dampening for the suspension assembly 10. The fixed connection 28 of the spring member 24 resists vertical movement of the axle 14 by exerting a biasing force toward a neutral position (FIG. 2). Resistance to vertical movement by the spring member 24 improves vehicle ride, by resisting lateral roll of the vehicle and improve loading dock performance by limiting vertical displacement of the axles 14 relative to the frame 16.

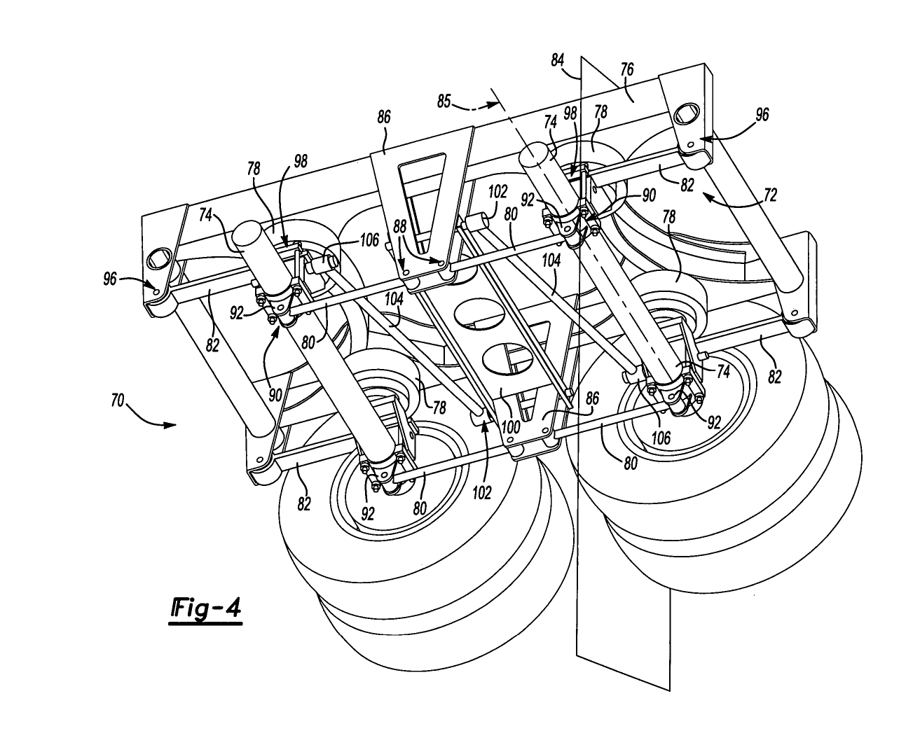

Referring to FIG. 4, another tandem axle suspension assembly 70 according to this invention includes a linkage assembly 72 that constrains and controls longitudinal movement of axles 74. The tandem axle suspension assembly 70 includes the axles 74 supported for movement relative to a frame 76 by air spring assemblies 78. The air spring assemblies 78 are disposed on each end of the axle 74, between the axle 74 and the frame 76.

A ladder frame 100 is mounted laterally between link plates 86. The ladder frame 100 includes pivotal connections 102 to a pair of lateral control links 104. Each of the lateral control links 104 attaches to the ladder frame 100 at one of the pivotal connection 102 and an axle mount 92 by way of a second pivotal connection 106. The second pivotal connection 106 is disposed laterally opposite the pivotally connection 102. The lateral control links 104 control and constraint lateral movement of the axles 74.

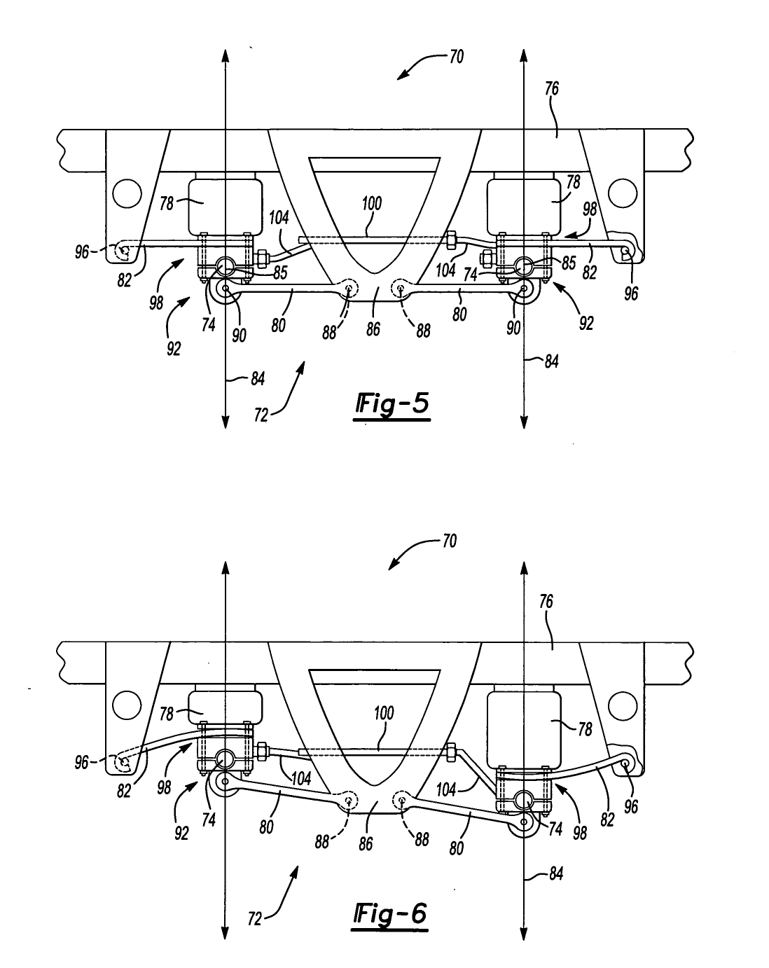

Referring to FIG. 5, the linkage assembly 72 includes a control rod 80 with a first pivotal connection 88 to the link plate 86 and a second pivotal connection 90 to the axle mount 92. A spring member 82 is pivotally attached to the frame 76 at a pivotal connection 96 and rigidly mounted to the axle mount 92 at a fixed connection 98. Preferably, the second pivotal connection 90 of the control rod 80 and the fixed connection 98 of the spring member 82 to the axle mount 92 are disposed within a common vertical plane 84. The vertical plane 84 extends transversely to an axis 85. From the axle mount 92, the control rod 80 and the spring member 82 extend on opposite sides of the vertical plane 84. The spring member 82 extends longitudinally to the pivotal connection 96 and the control rod 80 extends longitudinally to the pivotal connection 88 on the link plate 86.

Each axle 74 includes one of the air spring assemblies 78 mounted between the axle 74 and frame 76 at segments adjacent each end of the axles 74. Longitudinal movement of the axles 74 is constrained by the control rod 80 and the spring member 82. Preferably, the control rod 80 is mounted below the axle 74 and the spring member 82 is mounted above the axle 74.

Referring to FIG. 6, the linkage assembly 72 is shown with one axle 74 moved away from the frame 76 and the other moved toward the frame 76 to illustrate deformation of the spring member 82. Displacement of the axles 74 along with deformation of the spring member 82 is greatly exaggerated to illustrate operation of the linkage assembly 72. The spring member 82 exerts a torsion force on the axles 74 to resist roll movements of the vehicle. Vertical movement of the axle 74 is countered by the torsion force exerted by the spring member 82 in a direction opposite movement of the axle 74 and toward a neutral position (FIG. 5).

The fixed connection 98 causes the spring member 82 to bend instead of pivot in response to vertical displacement of the axles 74. The spring member 82 resists this bending, thereby exerting a biasing force opposite displacement of the axle 74. The biasing force exerted by the spring member 82 on the axle 74 counteracts roll forces on the axle 74. Resistance by the spring member 82 improves resistance to lateral roll and improves loading dock performance by limiting vertical displacement of the axle 74 relative to the frame 76.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

1. A vehicle suspension assembly for a vehicle having a frame, the assembly comprising:
an axle mountable transverse to the frame;
a control rod including a control rod pivot, said control rod pivotally connectable between the frame and said axle; and
a spring member comprising a first pivot connectable to the frame and a second fixed connection connectable to said axle.

2. The assembly as recited in claim 1, comprising a first and second air spring assembly supporting said axle relative to the frame.

3. The assembly as recited in claim 1, wherein said spring member and said control rod are parallel to one another.

4. The assembly as recited in claim 1, wherein said first pivot of said spring member and said control rod pivot are aligned within a common vertical plane.

5. The assembly as recited in claim 4, wherein said spring member and said control rod extend along a common side of said common vertical plane.

6. The assembly as recited in claim 4, wherein said spring member extends along an opposite side of said common vertical plane relative to said control rod.

7. The assembly as recited in claim 1, comprising a link plate, where said control rod and said spring member are pivotally attached to said link plate.

8. The assembly as recited in claim 1, comprising an axle mount attachable to said axle.

9. The assembly as recited in claim 8, comprising at least one lateral control arm comprising first and second segments, said lateral control arm disposed laterally relative to the frame where said first segment is attachable to the frame, and said second segment is attached to said axle mount.

10. The assembly as recited in claim 8, wherein said spring member is fixed to said axle mount and biases said axle toward a neutral position.

11. A tandem axle trailer suspension assembly for a vehicle having a frame, the assembly comprising:
a pair of axles supported relative to the frame;
a control rod including a control rod pivot pivotally connectable between each of said pair of axles and the frame; and
a spring member mountable between each of said pair of axles and the frame, said spring member including a first pivot connectable to the frame and a rigid connection to said pair of axles.

12. The assembly as recited in claim 11, wherein said spring member and said control rod are mounted substantially parallel to one another.

13. The assembly as recited in claim 12, wherein said first pivot of said spring member and said control rod pivot are within a common vertical plane.

14. The assembly as recited in claim 11, wherein said spring member and said control rod extend longitudinally along a common side of each of said pair of axles.

15. The assembly as recited in claim 11, wherein said spring member extends longitudinally along an opposite side of each of said pair of axles relative to said control rod.

16. The assembly as recited in claim 11, comprising at least one lateral control arm mounted laterally between each of said pair of axles and the frame.

17. The assembly as recited in claim 11, wherein said spring member opposes displacement of each of said pair of axles.
